(19) United States
(12) Patent Application Publication
(10) Pub. No.: US 2019/0178067 A1
(43) Pub. Date: Jun. 13, 2019

(54) ENHANCED RESERVOIR MODELING FOR STEAM ASSISTED GRAVITY DRAINAGE SYSTEM

(71) Applicants: Benjamin Mcadoo, Houston, TX (US); Joshua Raymond Snitkoff, Houston, TX (US); Eugene Stolboushkin, Houston, TX (US); Tarik Abdelfattah, Houston, TX (US); Jose Rafael Gonzalez, Fulshear, TX (US)

(72) Inventors: Benjamin Mcadoo, Houston, TX (US); Joshua Raymond Snitkoff, Houston, TX (US); Eugene Stolboushkin, Houston, TX (US); Tarik Abdelfattah, Houston, TX (US); Jose Rafael Gonzalez, Fulshear, TX (US)

(73) Assignee: Baker Hughes, a GE company, LLC, Houston, TX (US)

(21) Appl. No.: 15/838,696

(22) Filed: Dec. 12, 2017

(51) Int. Cl. E21B 43/24; G06F 17/50; G01F 1/86

(52) U.S. Cl. CPC E21B 43/2406; G01F 1/86; G06F 17/5009

(57) ABSTRACT

Examples of techniques for enhanced reservoir modeling are disclosed. In one example implementation according to aspects of the present disclosure, a computer-implemented method includes estimating, by a processing device, a plurality of reservoir fluid values. The reservoir fluid values includes a density of the fluid, a velocity of the fluid, a pressure differential of the fluid, a temperature of the fluid, a viscosity, and an absolute pressure of the fluid. The method further includes modeling, by the processing device, a mass flow rate based at least in part on the plurality of reservoir fluid values. The method further includes applying the modeled mass flow rate to a wellbore operation.

### BACKGROUND

In the resource recovery industry, resources (such as hydrocarbons, steam, minerals, water, metals, etc.) are often recovered from boreholes in formations containing the targeted resource. Many wells include long horizontal sections of a production well, where the resources in the formation include both liquid and gas phases. When only the liquid is desired as the targeted resource, the gas produced with the liquid is a waste product. Gas breakthrough into the well reduces production from other zones and lowers overall recovery of liquids.

In a steam assisted gravity drainage (SAGD) system, an injection well is used to inject steam into a formation to heat the oil within the formation to lower the viscosity of the oil so as to produce the liquid resource (mixture of oil and water) by a production well. The injector well generally runs horizontally and parallel with the production well. Steam from the injector well heats up the thick oil in the formation, providing the heat that reduces the oil viscosity, effectively mobilizing the oil in the reservoir. After the vapor condenses, the liquid emulsifies with the oil, the heated oil and liquid water mixture drains down to the production well. An ESP is often used to pull the oil and water mixture out from the production well. Water and oil go to the surface, the water is separated from the oil, and the water is reinjected back into the formation by the injector well as steam, for a continuous process.

Inflow control devices (ICDs) are used to even out production from sections of the horizontal production well. Without ICDs, the heel of the production well may produce more of the targeted resource than the toe of the production well. Likewise, heterogeneities in the reservoir may result in uneven flow distributions. The ICDs are employed to impose pressure distribution along a wellbore operation to control and distribute the production rate along the wellbore operation.

Due to irregularities in formations in which the steam is injected, the heat from the steam may not be distributed through the formation evenly, resulting in uneven production results.

### SUMMARY

Embodiments of the present invention are directed to a computer-implemented method for enhanced reservoir modeling for a steam assisted gravity drainage system. A non-limiting example of the computer-implemented method includes estimating, by a processing device, a plurality of reservoir fluid values. The reservoir fluid values includes a density of the fluid, a velocity of the fluid, a pressure differential of the fluid, a temperature of the fluid, a viscosity, and an absolute pressure of the fluid. The method further includes modeling, by the processing device, a mass flow rate based at least in part on the plurality of reservoir fluid values. The method further includes applying the modeled mass flow rate to a wellbore operation.

Embodiments of the present invention are directed to a system. A non-limiting example of the system includes a production well for extracting hydrocarbons from a formation, the production well comprising a plurality of inflow control devices spaced longitudinally along a horizontal section of the production well. The system further includes an injection well for injecting steam into the formation. The system further includes a memory comprising computer readable instructions and a processing device for executing the computer readable instructions for performing a method for enhanced reservoir modeling for a steam assisted gravity drainage system. A non-limiting example of the method includes estimating, by the processing device, a plurality of reservoir fluid values. The reservoir fluid values includes a density of the fluid, a velocity of the fluid, a pressure differential of the fluid, a temperature of the fluid, and an absolute pressure of the fluid. The method further includes modeling, by the processing device, a mass flow rate through each of the plurality of inflow control devices based at least in part on the plurality of reservoir fluid values. The method further includes applying the modeled mass flow rate to control an aspect of at least one of the production well and the injection well.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The following descriptions should not be considered limiting in any way. With reference to the accompanying drawings, like elements are numbered alike:

FIG. 1 depicts a partial sectional and schematic view of an embodiment of an inflow control device (ICD), according to aspects of the present disclosure;

FIG. 2 depicts a schematic view of an embodiment of a tubular system incorporating the ICD of FIG. 1, according to aspects of the present disclosure;

FIG. 3 depicts a schematic view of another embodiment of a tubular system incorporating the ICD of FIG. 1, according to aspects of the present disclosure;

FIG. 4 depicts a graph of a saturation curve, according to aspects of the present disclosure;

FIG. 5 depicts a graph illustrating the intersection of an inlet flow temperature and the saturation curve of FIG. 4 to determine the pressure drop required to induce steam formation within the ICD, according to aspects of the present disclosure;

FIG. 6 depicts a top view, a front view, and a left view of an oil-bearing reservoir (e.g., the formation 24) of a geological formation, according to aspects of the present disclosure;

FIG. 7 depicts an example of an oil-bearing formation inside a geological formation, according to aspects of the present disclosure;

FIG. 8 depicts an example of a formation broken into grid blocks, according to aspects of the present disclosure;

FIG. 9 depicts an example of flow vectors in the formation, according to aspects of the present disclosure;

FIG. 10 depicts the initial condition of a reservoir and two possible ways it could develop, according to aspects of the present disclosure;

FIG. 11 depicts a saturation curve 1100 of water plotted as pressure;

FIG. 12 depicts a mass flow rate plotted over the pressure difference, according to aspects of the present disclosure.

FIG. 13 depicts a graph of mass flow rate, according to aspects of the present disclosure.

FIG. 14 depicts a method for enhanced reservoir modeling for a steam assisted gravity drainage system, according to aspects of the present disclosure; and

FIG. 15 depicts a cloud computing environment according to aspects of the present disclosure.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

A detailed description of one or more embodiments of the disclosed apparatus and method are presented herein by way of exemplification and not limitation with reference to the Figures.

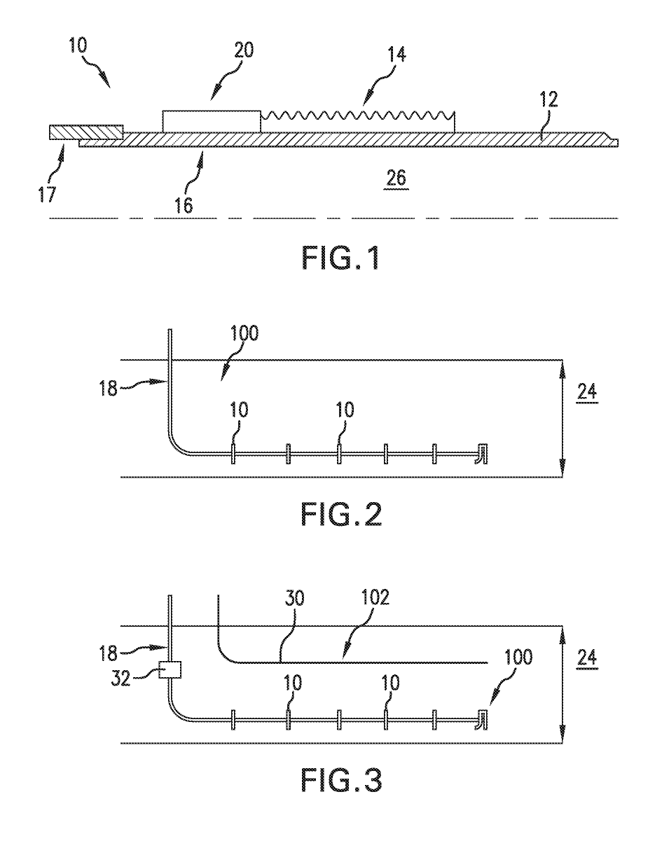

According to embodiments described herein, and with reference to FIG. 1, an inflow control device (ICD) 10 is usable with a tubular system 100 (FIGS. 2 and 3). In some embodiments, the ICD 10 can be used to reduce gas breakthrough and/or gas production into the tubular system 100, and/or to control a thermal gradient in a formation 24 (FIGS. 2 and 3). The ICD 10 is particularly useful with a production tubular 12, which may refer to, but is not limited to, one or more of a screen 14, liner, casing, piping, base pipe 16, coupling 17, and production string, all of which are disposed within a borehole, such as, but not limited to a borehole of a production well 18. The ICD 10 includes a flow device 20 having an outlet (not shown) and the screen 14. The ICD 10 is mounted on the base pipe 16 which is in fluid communication with the outlet 22 of the ICD 10. The base pipe 16 is at least part of the production tubular 12 and disposed radially interiorly of the ICD 10. Flow from a formation 24 enters the ICD 10 through the screen 14. Sand from the formation 24 is screened out of the ICD 10 by the screen 14, such that substantially only fluid is within the flow within the ICD 10. From the screen 14, the fluid flow travels longitudinally to the flow device 20, travels through the flow device 20, and is then exhausted through the outlet and into the interior 26 of the base pipe 16. As will be further described below, embodiments of the ICD 10 reduce the gas mass flow rate for a given drawdown, allow for higher rates of production of targeted liquid resources and increased overall recovery, and control the thermal gradient of the formation 24.

FIGS. 2 and 3 schematically depict embodiments of the tubular system 100 in which the ICD 10 can be employed, although the ICD 10 may be employed in other embodiments of tubular systems 100. The tubular systems 100 each include a production well 18 having a long horizontal section. A plurality of the ICDs 10 can be utilized and spaced longitudinally with respect to a production string to impose pressure distribution along the production borehole to control and distribute the production rate along the production well 18. The ICD 10 is applicable to production wells 18 that pass through reservoirs having fluids in both gas and liquid phases, such as demonstrated in FIG. 2. The concentration of gas in the formation 24 may vary. This concentration can be as high as 100%, but can also be small mass fractions, such as 1% by mass or less. Evening out the production helps to reduce gas breakthrough into the production well 18. The production well 18 closer to the origin of gas will produce more gas due to the higher concentration of gas in such a region.

As demonstrated in FIG. 3, the ICD 10 is also usable with a production well 18 that is employed in a gas driven well tubular system 100 where gas is injected to push liquid out of the formation 24, such as, but not limited to, steam assisted gravity drainage (SAGD) system 102, where an injection well 30 is used to inject steam into the formation 24 to heat heavy crude oil and bitumen to reduce the viscosity thereof, causing the heated oil to drain towards the production well 18 as a liquid. The liquid (such as oil and water mixture) is then produced by the production well 18.

In either system 100, an electric submersible pump (ESP) 32 may be employed within the production well 18 for reducing pressure in the well 18 downhole of the ESP 32 and increasing the drawdown. The drawdown is the difference between the reservoir pressure in the formation 24 and the pressure in the interior 26 of the production tubular 12. In one embodiment, the ESP 32 in the SAGD system 102 may be limited to about 1.5% steam mass fraction, but since it is undesirable to reduce the pump rate of the ESP 32 in order to limit the production of steam in an ICD 10, because that would deleteriously impact the production flow rate, embodiments of the ICD 10 described herein additionally provide for a reduced mass flow rate as a function of increasing gas fraction for a given pressure drop across each ICD 10.

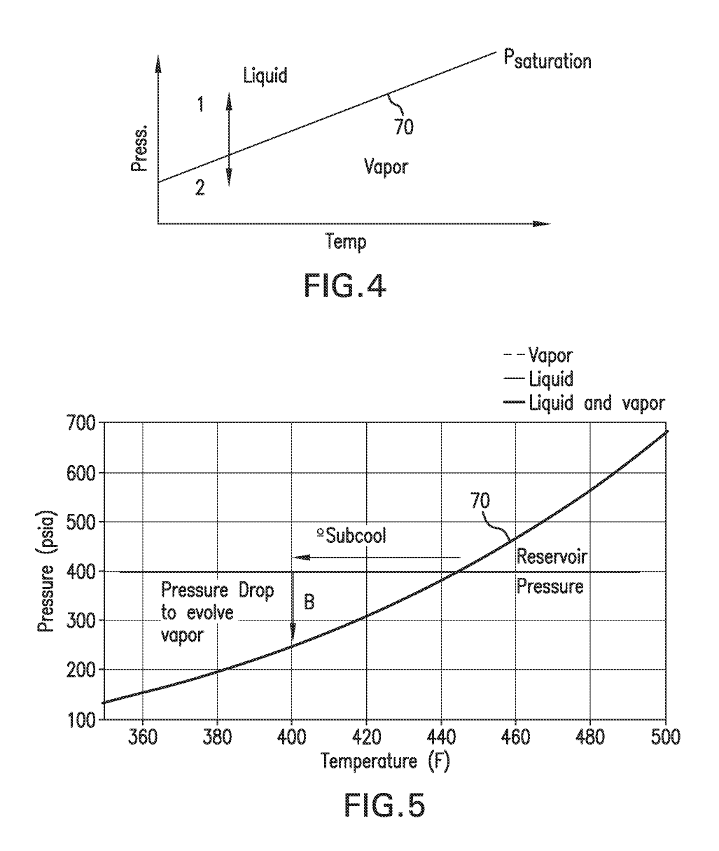

With continued reference to FIG. 3, and additional reference to the thermodynamic diagram for water shown in FIG. 4, when steam is injected into the formation 24 from the injection well 30, it condenses to combine with the oil, and the resultant fluid mixture is pulled out of the production well 18. The process of pulling the fluid out creates a pressure drop. The Y-axis in the graph of FIG. 4 indicates pressure, the X-axis indicates temperature, and the curve represents a saturation curve 70. A fluid that exists on the saturation curve 70 will exist in some combination of steam and gas and liquid. Fluid above the curve 70 will be all liquid, also termed subcooled liquid. Fluid below the curve 70 will be all gas, also termed superheated steam. The fluid in the formation 24 entering the ICD 10 in the SAGD system 102 exists in a condition 1, the subcooled liquid. However, if the pressure drop experienced by the liquid is significant enough within the flow device 20, the fluid can drop to condition 2, saturated mixture with evolved steam or even superheated steam. Condition 2 can also lie on the saturation curve 70, wherein some mixture of steam and liquid occurs. That is, in the SAGD system 102, steam occurs when the drawdown pressure causes the fluid to go from the subcooled state to a superheated or saturated condition.

SAGD wells in the SAGD system 102 are designed to operate at a certain amount of subcool, which is the difference between the saturation temperature at the well pressure and the temperature of the fluid entering the well. Lowering subcool increases recovery efficiency, but also promotes steaming in localized hotspots. In FIG. 5, “B” shows the allowable pressure drop before flashing occurs. If one of the zones has a smaller subcool, due to hotspots, the pressure drop B will cause flashing.

It is often desirable to model reservoirs prior to drilling the well in order to predict the construction of the reservoir. Current modeling techniques can be inaccurate and provide similar flow characterizations for very different downhole environments. This is because existing models only use fluid properties, velocity, and differential pressure to create flow characterizations, which can be misleading of what the reservoir is actually experiencing. The present techniques address these shortcomings by creating flow characterization curves at reservoir conditions that account for sudden changes through the ICD 10 rather than general flow behaviors of flow control devices at ambient conditions. In particular, the present techniques additional consider thermal advance oil recovery and absolute pressure variables. This creates a flow characterization that is a better predictor of actual occurrences within the reservoir. Accordingly, models can be created with more detailed downhole scenarios, which allows for better oil recovery.

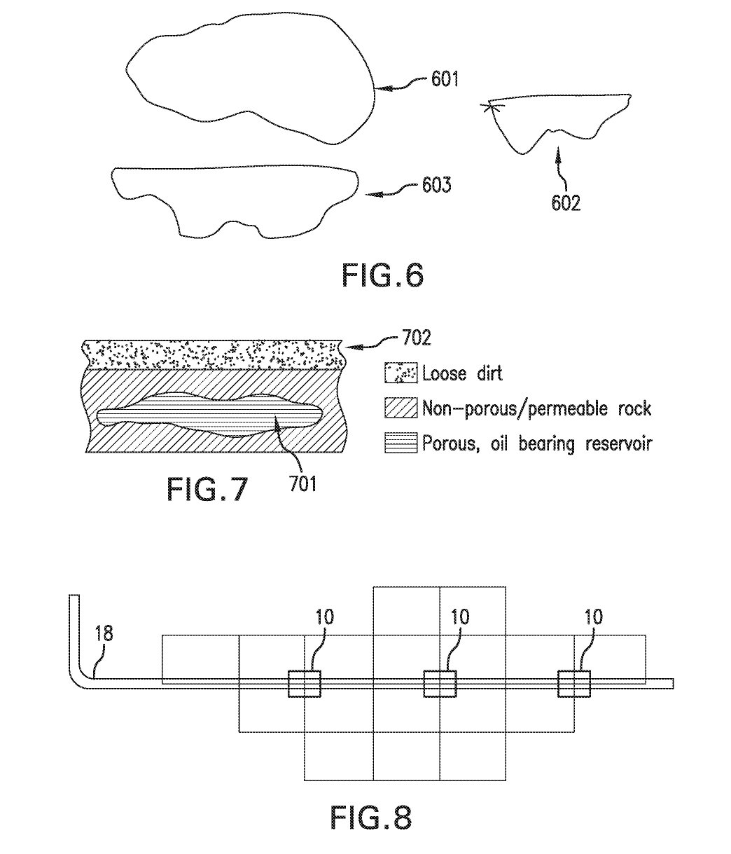

FIG. 6 depicts a top view 601, a front view 602, and a left view 603 of an oil-bearing reservoir (e.g., the formation 24) of a geological formation, according to aspects of the present disclosure. FIG. 7 depicts an example of an oil-bearing formation 701 inside a geological formation 702, according to aspects of the present disclosure.

Using seismic surveys, drilling data, and other data, a model of the geological formation 702 is created in a reservoir solver. As depicted in FIG. 8, the reservoir solver creates a 3D (or 2D) model of the shape of the geological formation. The reservoir solver breaks the 3D shape into grid blocks. Each grid block has parameters of porosity, permeability, pressure, temperature, fluid type, and other parameters. FIG. 8 depicts a simplified 2D model of a reservoir, according to aspects of the present disclosure. The formation is broken into grid blocks. The well trajectory is plotted and modeled as a pipe with known diameter. The ICD 10 are positioned along the well 18. Each ICD is an inlet whereby reservoir fluid enters the well 18 as described herein.

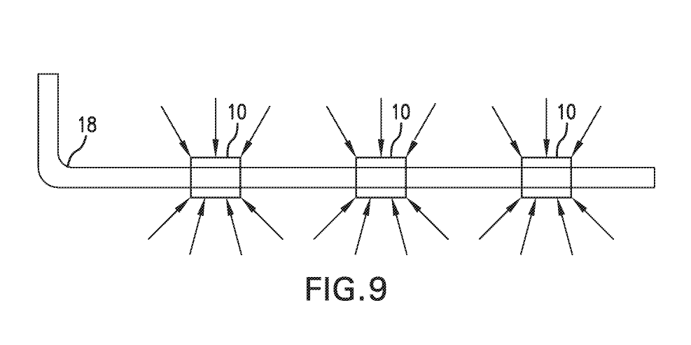

Using numerical methods, usually with the assumption of Darcy flow, reservoir models find a solution that predicts the flow vectors of the fluid in the formation. FIG. 9 depicts an example of flow vectors (represented in FIG. 9 by arrows) in the formation, according to aspects of the present disclosure. Each vector predicts direction and velocity of fluid flow. This is analogous to predicting the mass flow rate. Accurate prediction of the mass flow rate at each step is necessary for simulating the development of the reservoir over the life of the well.

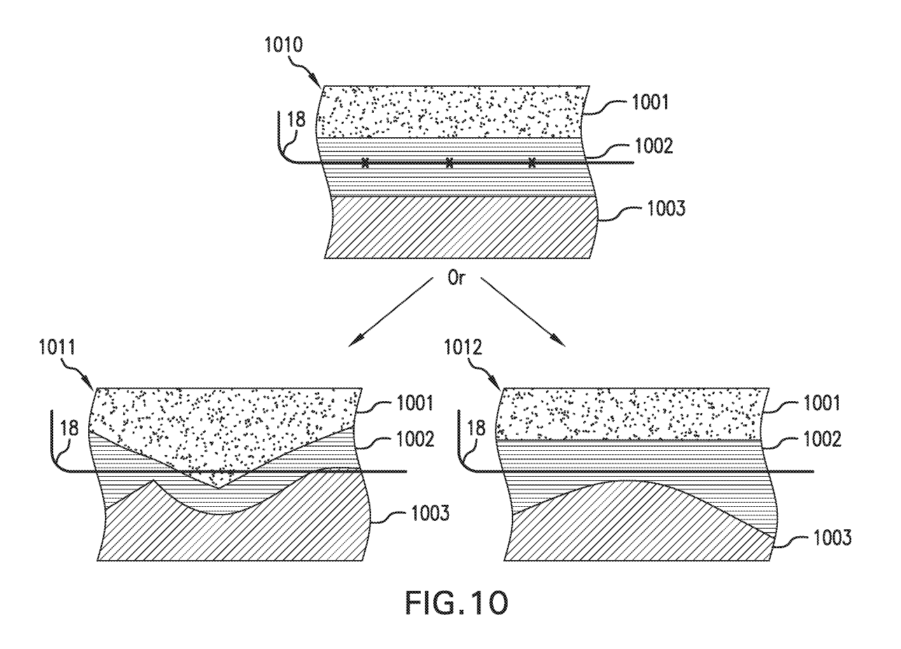

FIG. 10 depicts the initial condition of a reservoir and two possible ways it could develop, according to aspects of the present disclosure. This figure shows that accurate modeling of the reservoir development is critical to understand how the reservoir will behave with time. This drives equipment selection, well planning, reserves booking, and operating procedures. The diagram 1010 represents an initial state of the reservoir, the diagram 1011 represents a first future state of the reservoir, and the diagram 1012 represents a second future state of the reservoir. Each of the diagrams 1010, 1011, 1012 includes a gas zone 1001, an oil zone 1002, and a water zone 1003. The first later state depicted in the diagram 1011 and the second later state depicted in the diagram of 1012 are both possible; however, one of the later states is accurate and the other is a result of poor simulation results.

More particularly, the diagram 1011 depicts a case where there is gas breakthrough in the middle and water breakthrough on the end. The diagram 1012 shows a case of water breakthrough in the middle. These two scenarios have different solutions in terms of operation and equipment. If it is, for example, planned for the water breakthrough case and the gas breakthrough case occurs, it is likely that the well is far from optimized. This figure highlights the importance of accurate reservoir modelling. If the models are not accurate, a predicted scenario can be very different than the actual well conditions, and the well would be operating at a non-optimal condition.

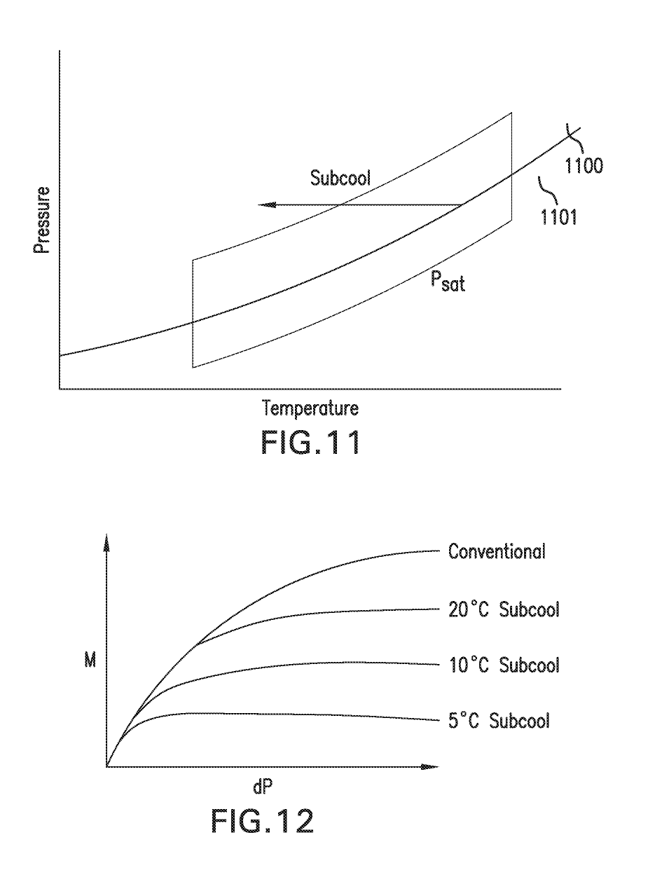

In SAGD systems, steam is injected to heat up the oil as described herein to mobilize the oil and draw it out through the wellbore. FIG. 11 depicts a saturation curve 1100 of water plotted as pressure. The conditions in the zone 1101 are those in which SAGD operation takes place. In particular, FIG. 11 depicts the range in which typical SAGD operations are taking place, namely that they are operating close to the saturation curve. By typical SAGD operations, it is meant in the fields, the area inside the zone 1101 is typical for wells in the field.

ICDs (e.g., the ICD 10) and their flow performance, as it currently exists, are based on conventional oil reservoirs, where phase change behavior is not encountered. Existing reservoir simulations predict the mass flow rate (\dot{m}) through the ICD 10 as a function of the pressure difference (Δp), viscosity of the fluid, and density of the fluid. Each ICD includes a given response for these variables. Existing reservoir simulators predict either mass flow rate or pressure differential based on a set of fluid properties (i.e., viscosity of the fluid and density of the fluid) depending on the constraints and objective functions set by the user.

In the case of a SAGD implementation, as depicted in FIG. 12, the mass flow rate (\dot{m}) is a function of the degrees subcool, which is related to pressure and temperature. Alternatively, for saturated flow at low quality, a similar phenomenon occurs. Steam quality is a measure of the mass fraction of steam. For example, 5% quality means that the fluid is, by mass, 5% steam and 95% water.

The present techniques make the modeling of ICD performance in a SAGD implementation a function of absolute pressure, temperature, pressure difference (Δp), viscosity, and density of the fluid. This technique allows capturing of phase change behavior in the ICD. For SAGD conditions, this allows more accurate predictions of well performance. These predictions are used for well trajectory in a reservoir, selecting equipment to implement in a well, booking reserves and predicting cash flow, and the like. As an example, the mass flow rate (that accounts for absolute pressure, temperature, pressure difference (Δp), viscosity, and density) can be used to determine how much oil may be produced, to establish (or modify) a drilling plan, to implement different numbers of ICDs, to determine location for placement of ICDs, to initiate an ICD flow restriction, to determine an amount of steam to use in the SAGD system, to determine a pump pressure, and the like.

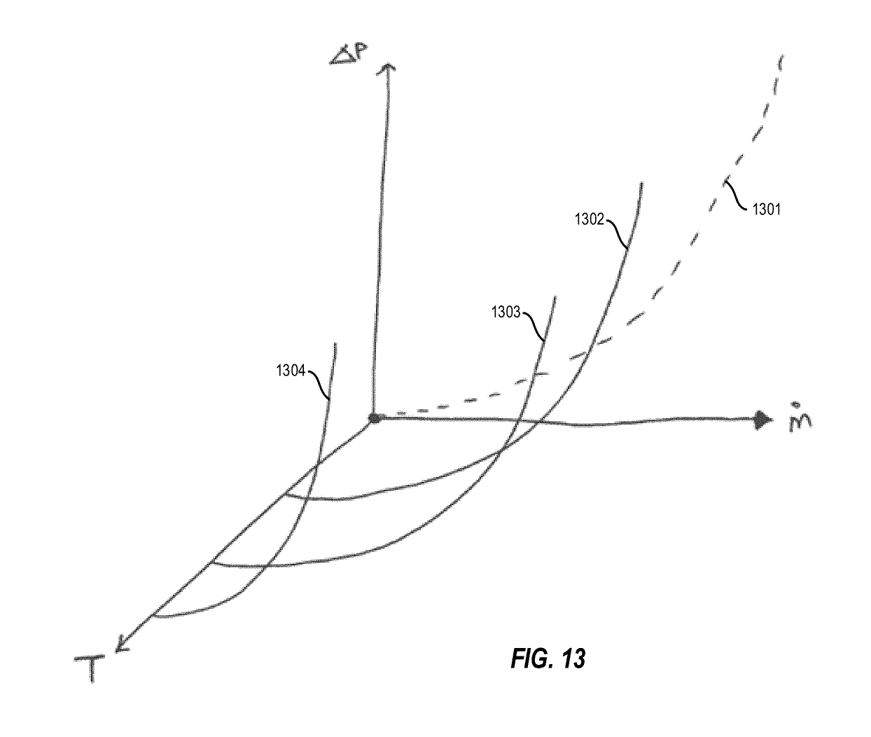

FIG. 13 depicts a graph 1300 of a mass flow rate, according to aspects of the present disclosure. In particular, the mass flow rate of the graph 1300 is plotted as a function as follows:

\dot{m}=f(ρ,v,Δp,T,P_{abs})

where ρ represents the density of the fluid, v represents the velocity of the fluid, Δp represents the pressure differential of the fluid, T represents the temperature of the fluid, and P_{abs} represents the absolute pressure of the fluid. Additionally, viscosity μ can be a variable controlling mass flow rate. It should be appreciated that each of these variables are based on estimates generated from survey data and the like as described herein and are subject to change over time.

In FIG. 13, an example of an existing model 1301 is depicted by the dashed line. In this example, the mass flow rate is simply a function of density, velocity, and pressure differential without any consideration of temperature or absolute pressure. Three different mass flow rate curves 1302, 1303, and 1304 are graphed in accordance with the present techniques, accounting for temperature and absolute pressure. Together, these curves 1302, 1303, and 1304 (along with additional curves not shown), make up a three-dimensional surface.

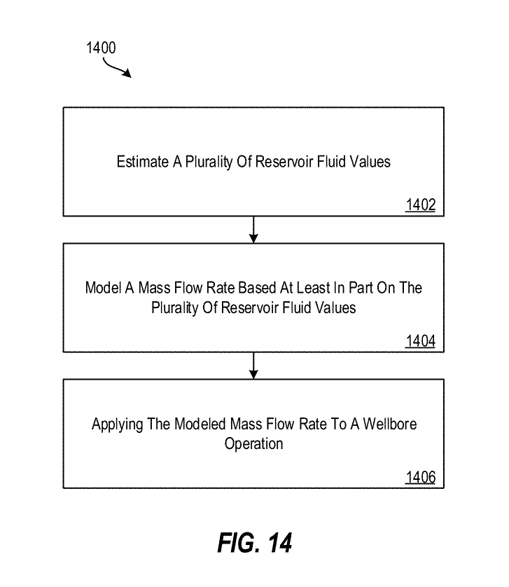

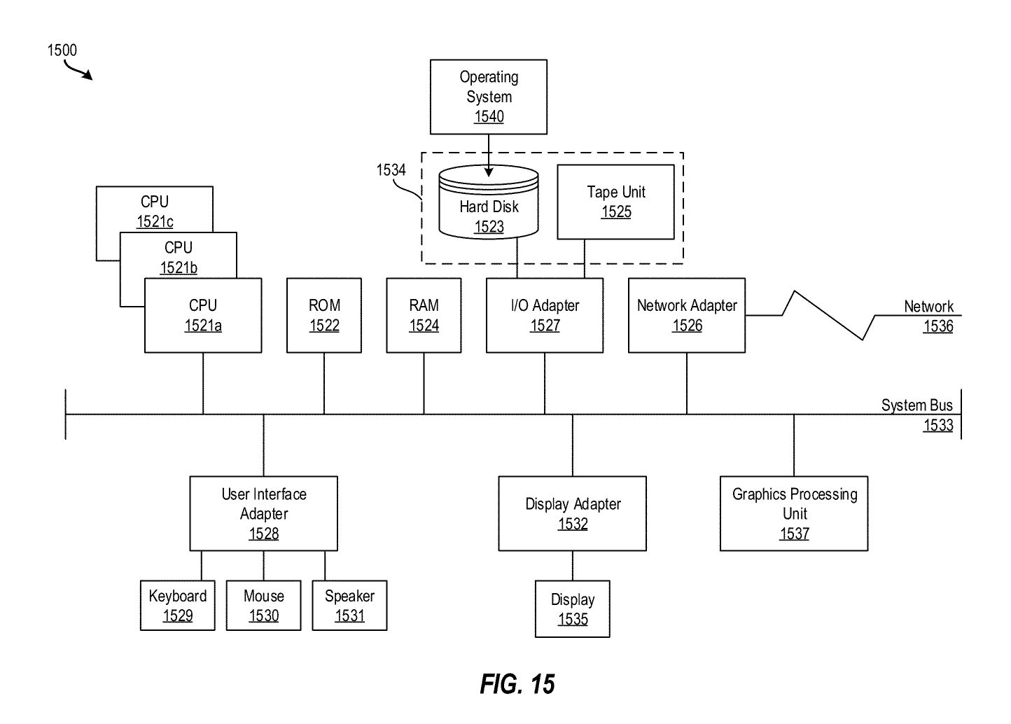

FIG. 14 illustrates a flow diagram of a method 1400 for enhanced reservoir modeling for a steam assisted gravity drainage system, according to examples of the present disclosure. The method 1400 can be implemented using any suitable processing system and/or processing device, such as the processing system 1500 of FIG. 15 described herein). The steps described regarding FIG. 14 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the steps described can be performed using any suitable a combination of hardware and programming. The programming can be processor executable instructions stored on a tangible memory, and the hardware can include a processing device for executing those instructions. Thus a system memory can store program instructions that when executed by the processing device implement the engines described herein. Other engines can also be utilized to include other features and functionality described in other examples herein.

At block 1402, the method 1400 includes estimating a plurality of reservoir fluid values. The reservoir fluid values include a density of the fluid, a velocity of the fluid, a pressure differential of the fluid, a temperature of the fluid, and an absolute pressure of the fluid. The reservoir fluid values can be based on drilling data, seismic data, and the like.

At block 1404, the method 1400 includes modeling a mass flow rate based at least in part on the plurality of reservoir fluid values. That is, the mass flow rate is based on the density of the fluid, the velocity of the fluid, the pressure differential of the fluid, the temperature of the fluid, and the absolute pressure of the fluid. The mass flow rate is a vector that predicts a direction of fluid flow and a velocity of fluid flow. The mass flow rate can be modeled through an inflow control device, can be modeled in three dimensions, and can be a function of degrees subcool. Modeling the mass flow rate can include capturing a phase change behavior in an inflow control device.

At block 1406, the method 1400 includes applying the modeled mass flow rate to a wellbore operation. For example, applying the modeled mass flow rate to the wellbore operation includes implementing a flow restriction on at least one inflow control device. In another example, applying the modeled mass flow rate to the wellbore operation includes determining an amount of steam to use in the steam assisted gravity drainage system and injecting the determined amount of steam in the steam assisted gravity drainage system. In yet another example, applying the modeled mass flow rate to the wellbore operation includes generating a drilling plan and determining a number of inflow control devices to implement in the wellbore operation and a location along the wellbore for each of the number of inflow control devices

Additional processes also may be included, and it should be understood that the processes depicted in FIG. 14 represent illustrations, and that other processes may be added or existing processes may be removed, modified, or rearranged without departing from the scope and spirit of the present disclosure.

It is understood in advance that the present disclosure is capable of being implemented in conjunction with any other type of computing environment now known or later developed. For example, FIG. 15 illustrates a block diagram of a processing system 1500 for implementing the techniques described herein. In examples, processing system 1500 has one or more central processing units (processors) 1521a, 1521b, 1521c, etc. (collectively or generically referred to as processor(s) 1521 and/or as processing device(s)). In aspects of the present disclosure, each processor 1521 can include a reduced instruction set computer (RISC) microprocessor. Processors 1521 are coupled to system memory (e.g., random access memory (RAM) 1524) and various other components via a system bus 1533. Read only memory (ROM) 1522 is coupled to system bus 1533 and may include a basic input/output system (BIOS), which controls certain basic functions of processing system 1500.

Further illustrated are an input/output (I/O) adapter 1527 and a communications adapter 1526 coupled to system bus 1533. I/O adapter 1527 may be a small computer system interface (SCSI) adapter that communicates with a hard disk 1523 and/or a tape storage drive 1525 or any other similar component. I/O adapter 1527, hard disk 1523, and tape storage device 1525 are collectively referred to herein as mass storage 1534. Operating system 1540 for execution on processing system 1500 may be stored in mass storage 1534. A network adapter 1526 interconnects system bus 1533 with an outside network 1536 enabling processing system 1500 to communicate with other such systems.

A display (e.g., a display monitor) 1535 is connected to system bus 1533 by display adaptor 1532, which may include a graphics adapter to improve the performance of graphics intensive applications and a video controller. In one aspect of the present disclosure, adapters 1526, 1527, and/or 232 may be connected to one or more I/O busses that are connected to system bus 1533 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 1533 via user interface adapter 1528 and display adapter 1532. A keyboard 1529, mouse 1530, and speaker 1531 may be interconnected to system bus 1533 via user interface adapter 1528, which may include, for example, a Super I/O chip integrating multiple device adapters into a single integrated circuit.

In some aspects of the present disclosure, processing system 1500 includes a graphics processing unit 1537. Graphics processing unit 1537 is a specialized electronic circuit designed to manipulate and alter memory to accelerate the creation of images in a frame buffer intended for output to a display. In general, graphics processing unit 1537 is very efficient at manipulating computer graphics and image processing, and has a highly parallel structure that makes it more effective than general-purpose CPUs for algorithms where processing of large blocks of data is done in parallel.

Thus, as configured herein, processing system 1500 includes processing capability in the form of processors 1521, storage capability including system memory (e.g., RAM 1524), and mass storage 1534, input means such as keyboard 1529 and mouse 1530, and output capability including speaker 1531 and display 1535. In some aspects of the present disclosure, a portion of system memory (e.g., RAM 1524) and mass storage 1534 collectively store an operating system to coordinate the functions of the various components shown in processing system 1500.

Set forth below are some embodiments of the foregoing disclosure:

### Embodiment 1

A computer-implemented method for enhanced reservoir modeling for a steam assisted gravity drainage system, the method comprising: estimating, by a processing device, a plurality of reservoir fluid values, wherein the reservoir fluid values comprise a density of the fluid, a velocity of the fluid, a pressure differential of the fluid, a temperature of the fluid, a viscosity, and an absolute pressure of the fluid; modeling, by the processing device, a mass flow rate based at least in part on the plurality of reservoir fluid values; and applying the modeled mass flow rate to a wellbore operation.

### Embodiment 2

The method according to any previous embodiment, wherein the mass flow rate is a vector that predicts a direction of fluid flow and a velocity of fluid flow.

### Embodiment 3

The method according to any previous embodiment, wherein the plurality of reservoir fluid values are estimated based at least in part on one or more of a seismic survey and drilling data.

### Embodiment 4

The method according to any previous embodiment, wherein modeling the mass flow rate comprises modeling the mass flow rate through an inflow control device.

### Embodiment 5

The method according to any previous embodiment, wherein applying the modeled mass flow rate to the wellbore operation comprises implementing a flow restriction on the inflow control device.

### Embodiment 6

The method according to any previous embodiment, wherein applying the modeled mass flow rate to the wellbore operation comprises determining an amount of steam to use in the steam assisted gravity drainage system and injecting the determined amount of steam in an injection well using the steam assisted gravity drainage system.

### Embodiment 7

The method according to any previous embodiment, wherein applying the modeled mass flow rate to the wellbore operation comprises generating a drilling plan and determining a number of inflow control devices to implement in the wellbore operation and a location along the wellbore for each of the number of inflow control devices.

### Embodiment 8

The method according to any previous embodiment, wherein the mass flow rate is modeled in three dimensions.

### Embodiment 9

The method according to any previous embodiment, wherein the mass flow rate is a function of degrees subcool.

### Embodiment 10

The method according to any previous embodiment, wherein the mass flow rate is a function of steam quality when the fluid is saturated.

### Embodiment 11

The method according to any previous embodiment, wherein modeling the mass flow rate comprises capturing a phase change behavior in an inflow control device.

### Embodiment 12

A system comprising: a production well for extracting hydrocarbons from a formation, the production well comprising a plurality of inflow control devices spaced longitudinally along a horizontal section of the production well; an injection well for injecting steam into the formation; and a processing device for executing computer readable instructions stored in a memory, the computer readable instructions for performing a method for enhanced reservoir modeling for a steam assisted gravity drainage system, the method comprising: estimating, by the processing device, a plurality of reservoir fluid values, wherein the reservoir fluid values comprise a density of the fluid, a velocity of the fluid, a pressure differential of the fluid, a temperature of the fluid, and an absolute pressure of the fluid; modeling, by the processing device, a mass flow rate through each of the plurality of inflow control devices based at least in part on the plurality of reservoir fluid values; and applying the modeled mass flow rate to control an aspect of at least one of the production well and the injection well.

### Embodiment 13

The system according to any previous embodiment, wherein the mass flow rate is a vector that predicts a direction of fluid flow and a velocity of fluid flow.

### Embodiment 14

The system according to any previous embodiment, wherein the plurality of reservoir fluid values are estimated based at least in part on one or more of a seismic survey and drilling data.

### Embodiment 15

The system according to any previous embodiment, wherein the method further comprises implementing a flow restriction on at least one of the plurality of inflow control devices based at least in part on the modeled mass flow rate through the at least one of the plurality of inflow control devices.

### Embodiment 16

The system according to any previous embodiment, wherein controlling an aspect of the injection well comprises determining an amount of steam to use in the injection well and injecting the determined amount of steam in injection well.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A computer-implemented method for enhanced reservoir modeling for a steam assisted gravity drainage system, the method comprising:
estimating, by a processing device, a plurality of reservoir fluid values, wherein the reservoir fluid values comprise a density of the fluid, a velocity of the fluid, a pressure differential of the fluid, a temperature of the fluid, a viscosity, and an absolute pressure of the fluid;
modeling, by the processing device, a mass flow rate based at least in part on the plurality of reservoir fluid values; and
applying the modeled mass flow rate to a wellbore operation.

2. The computer-implemented method of claim 1, wherein the mass flow rate is a vector that predicts a direction of fluid flow and a velocity of fluid flow.

3. The computer-implemented method of claim 1, wherein the plurality of reservoir fluid values are estimated based at least in part on one or more of a seismic survey and drilling data.

4. The computer-implemented method of claim 1, wherein modeling the mass flow rate comprises modeling the mass flow rate through an inflow control device.

5. The computer-implemented method of claim 4, wherein applying the modeled mass flow rate to the wellbore operation comprises implementing a flow restriction on the inflow control device.

6. The computer-implemented method of claim 1, wherein applying the modeled mass flow rate to the wellbore operation comprises determining an amount of steam to use in the steam assisted gravity drainage system and injecting the determined amount of steam in an injection well using the steam assisted gravity drainage system.

7. The computer-implemented method of claim 1, wherein applying the modeled mass flow rate to the wellbore operation comprises generating a drilling plan and determining a number of inflow control devices to implement in the wellbore operation and a location along the wellbore for each of the number of inflow control devices.

8. The computer-implemented method of claim 1, wherein the mass flow rate is modeled in three dimensions.

9. The computer-implemented method of claim 1, wherein the mass flow rate is a function of degrees subcool.

10. The computer-implemented method of claim 1, wherein the mass flow rate is a function of steam quality when the fluid is saturated.

11. The computer-implemented method of claim 1, wherein modeling the mass flow rate comprises capturing a phase change behavior in an inflow control device.

12. A system comprising:
a production well for extracting hydrocarbons from a formation, the production well comprising a plurality of inflow control devices spaced longitudinally along a horizontal section of the production well;
an injection well for injecting steam into the formation; and
a processing device for executing computer readable instructions stored in a memory, the computer readable instructions for performing a method for enhanced reservoir modeling for a steam assisted gravity drainage system, the method comprising:
estimating, by the processing device, a plurality of reservoir fluid values, wherein the reservoir fluid values comprise a density of the fluid, a velocity of the fluid, a pressure differential of the fluid, a temperature of the fluid, and an absolute pressure of the fluid;
modeling, by the processing device, a mass flow rate through each of the plurality of inflow control devices based at least in part on the plurality of reservoir fluid values; and
applying the modeled mass flow rate to control an aspect of at least one of the production well and the injection well.

13. The system of claim 12, wherein the mass flow rate is a vector that predicts a direction of fluid flow and a velocity of fluid flow.

14. The system of claim 12, wherein the plurality of reservoir fluid values are estimated based at least in part on one or more of a seismic survey and drilling data.

15. The system of claim 12, wherein the method further comprises implementing a flow restriction on at least one of the plurality of inflow control devices based at least in part on the modeled mass flow rate through the at least one of the plurality of inflow control devices.

16. The system of claim 12, wherein controlling an aspect of the injection well comprises determining an amount of steam to use in the injection well and injecting the determined amount of steam in injection well.
